(19) United States
(12) Patent Application Publication
(10) Pub. No.: US 2026/0134881 A1
(43) Pub. Date: May 14, 2026

(54) Magnetic Recording Writer With Improved Side Shield

(71) Applicant: Headway Technologies, Inc., Milpitas, CA (US)

(72) Inventors: Ying Liu, San Jose, CA (US); Yuhui Tang, Milpitas, CA (US); Jiun-Ting Lee, Sunnyvale, CA (US); Ping-Wei Zhuang, Livermore, CA (US); Yue Liu, Fremont, CA (US)

(21) Appl. No.: 18/944,989

(22) Filed: Nov. 12, 2024

(51) Int. Cl. G11B 5/31; G11B 5/11

(52) U.S. Cl. CPC G11B 5/3116; G11B 5/11

(57) ABSTRACT

A magnetic recording writer is disclosed. The writer can include a main pole and side shields that have a first sidewall portion proximate to the ABS facing the curved sidewalls of the main pole and formed substantially conformal to the curved sidewalls up to a height of about 10 to 200 nm above the ABS, a second sidewall portion proximate to the corner connecting the first flared sidewalls and the curved sidewalls of the main pole and formed substantially conformal to the curved sidewalls up to the height of about 10 to 200 nm above the ABS, a third sidewall portion connected to the second sidewall portion and formed substantially conformal to the first flared sidewall, and a fourth sidewall portion connected to the third sidewall portion and formed substantially parallel to the ABS; and a side gap separating the main pole from each side shield.

### TECHNICAL FIELD

Embodiments of the present disclosure relate generally to a new writer for magnetic recording heads, such as perpendicular magnetic recording (PMR), microwave assisted magnetic recording (MAMR), and other magnetic recording heads of similar structure, used in hard disk drives.

### BACKGROUND

As the data areal density in hard disk drive (HDD) writing increases, writers and media bits are both required to be made in smaller sizes. However, as the writer size shrinks, its writability degrades. In today's PMR and MAMR writer design, the geometries and dimensions of the main pole and side shields are key factors for both overwrite and dBER (delta bit error rate) performance in hard disk drives (HDD). In a fully coupled shield (FCS) where the trailing shield, leading shield, and side shields completely surround the main pole at the ABS, the side shields are first plated on the leading shield, then a conformal non-magnetic material is deposited to form a leading gap and side gaps on the exposed surface of leading shield, and sidewalls of the side shields, respectively. Next, the main pole is plated on the leading gap and side gaps. As a result, the main pole shape proximate to the ABS is mainly defined by the shape of adjacent portions of the side shields. There is always flux leakage between the side shields and main pole due to thin side gaps in current writer designs. A writer that can deliver or pack higher bits per inch (BPI) and higher tracks per inch (TPI) is essential to the area density improvement. If writeability can be sustained, the main pole size must shrink, and a thinner write gap at the main pole trailing (top) surface and a narrower side gap adjoining the main pole sides in the cross-track direction are preferred for better track field gradient (Hy_grad, BPI) and cross-track field gradient (Hy_grad_x, TPI), respectively. However, in current PMR and MAMR writers, the side shield (SS) either couples to the main pole (MP) with a conformal side gap or separates thoroughly from the MP after the MP tip.

Therefore, there is a need to control the decoupling distance between the SS and MP near air bearing surface (ABS) and off ABS for an improved writer design with better MP field release and effective shielding in the cross track direction. The improved writer design can effectively increase TPI capability with little BPI tradeoff, resulting in an overall areal density capacity (ADC) gain over conventional writer designs.

### SUMMARY

Broadly, embodiments of the present disclosure provide a magnetic recording writer with better balanced volume distribution to achieve an increased areal density capacity (ADC) over conventional writer designs by effectively increasing TPI capability with little BPI tradeoff.

In some embodiments according to the present disclosure, a magnetic recording writer can include a main pole having a front portion and a back portion, the front portion includes a pole tip at an air bearing surface (ABS) plane, a pole tip thickness in a down-track direction, and curved sidewalls on each side of a center plane that is orthogonal to the ABS and bisects the main pole, the back portion includes first flared sidewalls connecting to the curved sidewalls at corners and extending from the curved sidewalls at an angle between 0 and 45 degrees relative to planes parallel to the center plane; a shield structure including a side shield on each side of the center plane, a leading shield, and a trailing shield forming an all wrap around (AWA) shield structure, the side shields each comprise a first sidewall portion proximate to the ABS facing the curved sidewalls of the main pole and formed substantially conformal to the curved sidewalls up to a height of about 10 to 200 nm above the ABS, a second sidewall portion proximate to the corner connecting the first flared sidewalls and the curved sidewalls and formed substantially conformal to the curved sidewalls up to the height of about 10 to 200 nm above the ABS, a third sidewall portion connected to the second sidewall portion and formed substantially conformal to the first flared sidewall, and a fourth sidewall portion connected to the third sidewall portion and formed substantially parallel to the ABS; and a side gap separating the main pole from each side shield.

In some embodiments according to the present disclosure, the side gap includes a first side gap distance having a width of about 5 nm to 100 nm up to the height of about 10 to 200 nm above the ABS. In other embodiments, the side gap includes a first side gap distance having a width of about 30 nm to 80 nm.

In some embodiments according to the present disclosure, the side gap further includes a second side gap distance above the height of about 10 to 200 nm above the ABS and having a width of about 5 nm to about 200 nm more than the width of the first side gap distance.

In some embodiments according to the present disclosure, the second side gap distance is about 10 to about 300 nm.

In some embodiments according to the present disclosure, the first side gap distance is substantially uniform from the ABS up to the height of about 10 to 200 nm.

In some embodiments according to the present disclosure, the second side gap distance is substantially uniform from the height of about 10 to 200 nm up to the fourth sidewall portion formed substantially parallel to the ABS.

In some embodiments according to the present disclosure, the fourth sidewall portion is formed at a height of about 0.3 μm to 1.0 μm from the ABS.

In some embodiments according to the present disclosure, the third sidewall portion of each side shield is formed substantially at the same angle as the first flared sidewalls relative to planes parallel to the center plane.

In some embodiments according to the present disclosure, the first flared sidewalls are formed at an angle between 0 and 25 degrees relative to planes parallel to the center plane.

In some embodiments according to the present disclosure, the first flared sidewalls are formed at an angle between 30 and 45 degrees relative to planes parallel to the center plane.

In some embodiments according to the present disclosure, the third sidewall portion of each side shield is formed at an angle between 0 and 25 degrees relative to planes parallel to the center plane.

In some embodiments according to the present disclosure, the third sidewall portion of each side shield is formed at an angle between 30 and 45 degrees relative to planes parallel to the center plane.

In some embodiments according to the present disclosure, the third sidewall portion of each side shield is formed at an angle between 0 and 25 degrees relative to planes parallel to the center plane, and the third sidewall portion of each side shield is formed substantially at the same angle as the first flared sidewalls relative to planes parallel to the center plane.

In some embodiments according to the present disclosure, the third sidewall portion of each side shield is formed at an angle between 30 and 45 degrees relative to planes parallel to the center plane, and the third sidewall portion of each side shield is formed substantially at the same angle as the first flared sidewalls relative to planes parallel to the center plane.

In some embodiments according to the present disclosure, the first flared sidewalls are formed at an angle between 0 and 25 degrees relative to planes parallel to the center plane, and the back portion further includes second flared sidewalls extending from the first flared sidewalls at an angle between 30 and 60 degrees relative to planes parallel to the center plane.

In some embodiments according to the present disclosure, the second flared sidewalls extend from the first flared sidewalls starting at about 0.3 μm to 1.0 μm from the ABS.

In some embodiments according to the present disclosure, the fourth sidewall portion is closer to the ABS than the second flared sidewalls.

### BRIEF DESCRIPTION OF THE DRAWINGS

The accompanying drawings, which are incorporated in and constitute a part of this specification, exemplify various embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements and are not generally drawn to scale.

FIG. 1 is an ABS view of a writer according to some embodiments of the present disclosure using a process of record (POR) wherein the trailing shield, side shields, and leading shield form an all wrap around (AWA) shield structure around the main pole.

FIG. 2A is a top-down view of a conventional POR writer wherein the trailing shield and write gap are removed to depict the main pole and side shields.

FIG. 2B is a top-down view of the writer according to some embodiments of the present disclosure wherein the trailing shield and write gap are removed to depict the main pole and side shields.

FIG. 3A is a top-down view of another writer wherein the trailing shield and write gap are removed to depict the main pole and side shields.

FIG. 3B is a top-down view of the writer according to some embodiments of the present disclosure wherein the trailing shield and write gap are removed to depict the main pole and side shields.

FIGS. 4A-4C are comparisons of the static modeling result of the write field profile 15 nm below ABS for the writers of FIGS. 3A and 3B, in which static modeling is based on Maxwell equations. FIG. 4A is a comparison of the 5 kOe contour plot for the writers. FIG. 4B shows the write field (Hy) profile along the cross-track direction for the conventional writer and the writer according to some embodiments of the present disclosure. FIG. 4C shows the write field (Hy) profile along the down-track direction for the conventional writer and the writer according to some embodiments of the present disclosure.

FIGS. 5A-B show a stray field plot at media level (15 nm below ABS) through dynamic modeling of the stray field in (a) writer with a conventional side shield and (b) writer with the improved side shield.

### DETAILED DESCRIPTION

The present disclosure provides a magnetic recording writer is disclosed. In some embodiments, the writer can include a main pole having a front portion and a back portion, the front portion includes a pole tip at an air bearing surface (ABS) plane, a pole tip thickness in a down-track direction, and curved sidewalls on each side of a center plane that is orthogonal to the ABS and bisects the main pole, the back portion includes first flared sidewalls connecting to the curved sidewalls at corners and extending from the curved sidewalls at an angle between 0 and 45 degrees relative to planes parallel to the center plane; a shield structure including a side shield on each side of the center plane, a leading shield, and a trailing shield forming an all wrap around (AWA) shield structure, the side shields each comprise a first sidewall portion proximate to the ABS and facing the curved sidewalls of the main pole and formed substantially conformal to the curved sidewalls up to a height of about 10 to 200 nm above the ABS, a second sidewall portion proximate to the corner connecting the first flared sidewalls and the curved sidewalls and formed substantially conformal to the curved sidewalls up to the height of about 10 to 200 nm above the ABS, a third sidewall portion connected to the second sidewall portion and formed substantially conformal to the first flared sidewall, and a fourth sidewall portion connected to the third sidewall portion and formed substantially parallel to the ABS; and a side gap separating the main pole from each side shield.

In the drawings, the y-axis is in a cross-track direction, the z-axis is in a down-track direction, and the x-axis is in a direction orthogonal to the ABS and towards a back end of the writer structure. Thickness refers to a substantially down-track distance. It should be understood that thickness is the direction perpendicular to the film plane, typically 0˜30 degrees from the z-axis direction to create a MP surface slope in most of current writers. Width is a cross-track distance, and height is a distance from the ABS in the x-axis direction. In some of the drawings, a magnetic bit is considerably enlarged over actual size in order to more easily depict a magnetization therein.

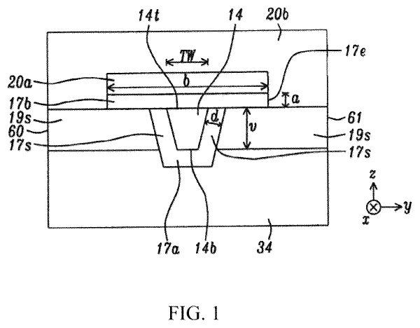

Referring to FIG. 1, an ABS view of a fully coupled shield (FCS) also known as an all wrap around (AWA) shield design currently fabricated by the inventors is shown wherein a main pole has a front portion referred to as a write pole with a medium facing side 14 comprising a leading edge 14b, and a trailing edge 14t which defines a track width TW. The main pole extends behind the plane of the ABS to a back portion (not shown) that is magnetically connected to the trailing shield comprising an upper kG magnetic layer 20b and a hot seed layer 20a where the hot seed layer and write gap 17b have a cross-track width b. The write gap has thickness a. In some embodiments, the magnetic layer 20b is made of a 16-19 kG material. In some embodiments, the hot seed layer 20a is made of a 19-24 kG material.

Side shields 19s are made of a magnetic layer, have a down-track thickness v, and are separated from the write pole by a side gap 17s having a cross-track width d. In some embodiments, the side shields 19s are made of a 10-16 kG magnetic layer. Each side shield has a top surface that adjoins trailing shield layer 20b between a side 17e of the write gap and a side 60 (or 61) of the side shield. There is also a leading shield 34, which is separated from leading edge 14b by a lead gap 17a. The leading shield adjoins the side shields, and with the magnetic layer 20b thereby forming an AWA shield design to improve field gradients in the down-track and cross-track directions as well as adjacent track erasure (ATE) performance.

In some embodiments, all shield layers and the main pole may be selected from one of CoFeN, CoFeNi, NiFe, or CoFe.

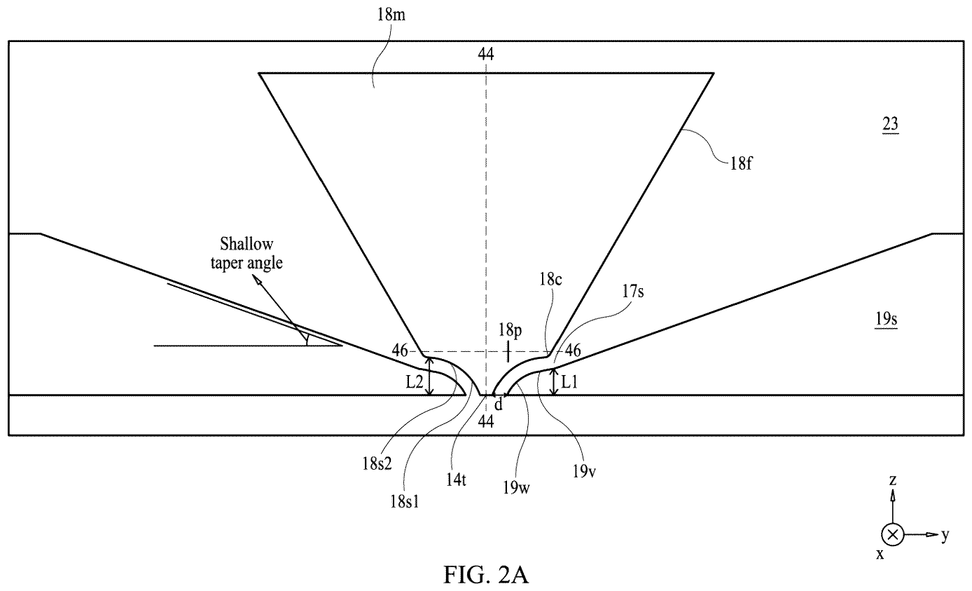

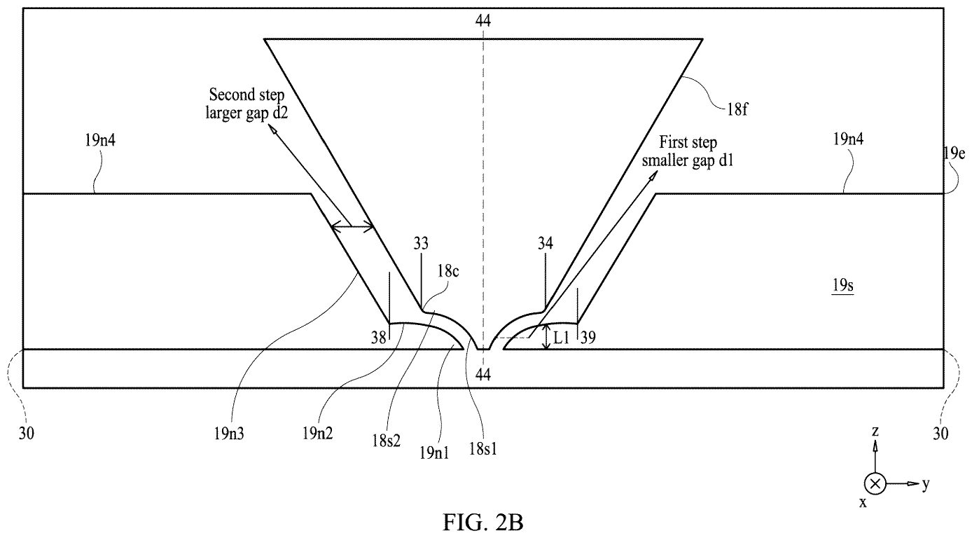

FIG. 2A shows a top-down view of the side shield and main pole structure of a conventional writer with the trailing shield and write gap removed. The main pole and side shields have a process of record (POR) design. Center plane 44-44 bisects the main pole including a back portion 18m and is aligned orthogonal to the ABS 30-30. A front portion of the main pole also known as the write pole 18p has a trailing edge 14t at the ABS, and has a curved sidewall on each side of the center plane wherein a first portion 18s1 of curved sidewall is proximate to the ABS, and a second portion 18s2 is proximate to corner 18c where the curved sidewall connects with flared side 18f of the main pole back portion. First portion 18s1 forms an attack angle y from 0 to 40 degrees, and preferably 18-20 degrees, with respect to center plane 44-44. In general, as the angle γ increases, the cross-track magnetic field gradient degrades. However, as angle γ approaches 0 degrees, the magnetic field from the main pole decreases dramatically. Without being bound to any particular theory, it is believed that 18 to 20 degrees for the angle γ is an optimum range to maintain an acceptable cross-track field gradient and magnetic field from the main pole. Preferably, a first portion of side shield sidewall 19w that is a side gap distance d from first portion 18s1 also is formed at the y angle with respect to the center plane.

Side shields 19s have a second sidewall portion 19v facing the write pole and formed substantially conformal to curved sidewall portion 18s2 up to height h1 where the sidewall 19v no longer follows the shape of the write pole and continues to an end 19e at sides 60 (or 61) of the side shield. The closest approach of main pole back portion 18m to the ABS is at plane 46-46 that includes corners 18c and is a second height h2 (e.g, >150 nm) from the ABS. In some embodiments, the second height h2 is 80 to 150 nm from the ABS. Curved sidewall portion 18 s2 and second sidewall portion 19v that are proximate to corners 18c form a maximum angle δ of about 60 degrees with respect to center plane 44-44.

In some embodiments, an insulation layer 23 separates the side shield 19s and the main pole. As shown in FIG. 2A, the side shields 19s have a shallow taper angle of about 10 to 40 degrees. As a result, the separation between the side shields 19s and the main pole will become larger will be larger the further above the ABS level.

FIG. 2B shows a top-down view of the side shield and main pole structure of a writer according to some embodiments of the present disclosure with the trailing shield and write gap removed. The features of the main pole are shared by both writer designs shown in FIGS. 2A and 2B, however FIG. 2A shows a writer having a conventional side shield and FIG. 2B shows a writer having the improve side shield according to some embodiments of the present disclosure.

In some embodiments, the side shields 19s each have a first sidewall section 19n1 proximate to the ABS 30-30 and substantially conforming to the shape of the first curved sidewall portion 18s1 of the main pole. In some embodiments, the first sidewall section 19n1 has a front end at the ABS and is separated from the first curved sidewall portion 18s1 of the main pole by a first side gap distance d1 as a first step of the side shields 19s. In some embodiments, the side shields 19s includes a second sidewall section 19n2 that is proximate to the corner 18c where the curved sidewall connects with flared side 18f of the main pole back portion. In some embodiments, the second sidewall section 19n2 is formed substantially conformal to curved sidewall portion 18s2 up to a height h1 of 10 to 200 nm at the first side gap distance d1 from the first portion 18s1. In some embodiments, the second sidewall section 19n2 is formed substantially conformal to curved sidewall portion 18s2 up to a height h1 of 10 to 200 nm at the first side gap distance d1 from the first portion 18s1 and up to dashed lines 33, 34. In some embodiments, the height h1 is 20 to 180 nm, 20 to 160 nm, 20 to 140 nm, 20 to 120 nm, 20 to 100 nm, 20 to 80 nm, 40 to 180 nm, 40 to 160 nm, 40 to 140 nm, 40 to 120 nm, 40 to 100 nm, 40 to 80 nm, 50 to 180 nm, 50 to 160 nm, 50 to 140 nm 50 to 150 nm, 50 to 140 nm, 50 to 130 nm, 50 to 120 nm, 50 to 110 nm, or 50 to 100 nm.

In some embodiments, the first side gap distance d1 is about 5 nm to 100 nm up to the height h1. In some embodiments, the first side gap distance d1 is about 20 nm to 60 nm up to the height h1. In some embodiments, the first side gap distance d1 is about 10 nm to 90 nm, 20 to 80 nm, 30 to 70 nm, 40 to 60 nm or 25 to 75 nm.

In some embodiments, the first side gap distance d1 is substantially uniform up to dashed lines 33, 34 which are perpendicular to the ABS 30-30 and parallel to the center plane 44-44. In some embodiments, the first side gap distance d1 is substantially uniform up to the corner 18c where the curved sidewall connects with flared side 18f of the main pole back portion.

In some embodiments, the portion of the second sidewall section 19n2 between dashed lines 33, 34 and dashed lines 38,39 remains substantially conformal to curved sidewall portion 18s2. In some embodiments, the portion of the second sidewall section 19n2 between dashed lines 33, 34 and dashed lines 38,39 is formed essentially parallel to the ABS 30-30 at a step height h1.

In some embodiments, as a second step of the side shields 19s, a back end of the second sidewall section 19n2 is connected to a front end of a third sidewall section 19n3 of the side shield 19s. In some embodiments, the third sidewall section 19n3 is substantially conformal to the flared side 18f of the main pole back portion at a second side gap distance d2 from the flared side 18f of the main pole. In other words, the taper angle of the flared portion 18f relative to dashed lines 33, 34 is substantially the same as the taper angle of the third side wall section 19n3 relative to dashed lines 38, 39. In some embodiments, the taper angle of the flared portion 18f relative to dashed lines 33, 34 and the taper angle of the third side wall section 19n3 relative to dashed lines 38, 39 is about 0 to 45 degrees. In some embodiments, the taper angle of the flared portion 18f relative to dashed lines 33, 34 and the taper angle of the third side wall section 19n3 relative to dashed lines 38, 39 is about 30 to 45 degrees. In some embodiments, the taper angle of the flared portion 18f relative to dashed lines 33, 34 and the taper angle of the third side wall section 19n3 relative to dashed lines 38, 39 is about 0 to 25 degrees.

In some embodiments, the width of the second side gap distance d2 is larger than the first side gap distance d1 by about 5 to 200 nm. In some embodiments, the second side gap distance d2 is larger than the first side gap distance d1 by about 10 to 180 nm, 20 to 170 nm, 30 to 160 nm, 40 to 150 nm, 50 to 140 nm, 60 to 130 nm, 70 to 120 nm, 20 to 180 nm, 20 to 160 nm, 20 to 140 nm, 20 to 120 nm, 20 to 100 nm, 20 to 80 nm, 40 to 180 nm, 40 to 160 nm, 40 to 140 nm, 40 to 120 nm, 40 to 100 nm, 40 to 80 nm, 50 to 180 nm, 50 to 160 nm, 50 to 140 nm 50 to 150 nm, 50 to 140 nm, 50 to 130 nm, 50 to 120 nm, 50 to 110 nm, or 50 to 100 nm.

In some embodiments, the second side gap distance d2 is about 10 to about 300 nm. In some embodiments, the second side gap distance d2 is about 20 to 280 nm, 30 to 270 nm, 40 to 260 nm, 50 to 250 nm, 60 to 240 nm, 70 to 230 nm, 80 to 220 nm, 90 to 210 nm, 100 to 200 nm, 100 to 190 nm, 100 to 180 nm, 100 to 170 nm, 100 to 160 nm, or 100 to 150 nm.

In some embodiments, the side shields 19s further include a fourth sidewall section 19n4 connected to a back end of the third sidewall section 19n3. In some embodiments, the fourth sidewall section 19n4 no longer follows the shape of the write pole and continues to an end 19e at sides 60 (or 61) of the side shield. In some embodiments, the fourth sidewall section 19n4 is essentially parallel to the ABS 30-30. In some embodiments, the fourth sidewall section 19n4 is about 0.3 μm to 1.0 μm from the ABS.

Without being bound to any particular theory, it is believed that the second step of the improved side shields enhances the shielding effect and reduces the side shield stray field. The width of the larger second side gap distance d2 can still allow for the release of MP flux to maintain the write field in the track center.

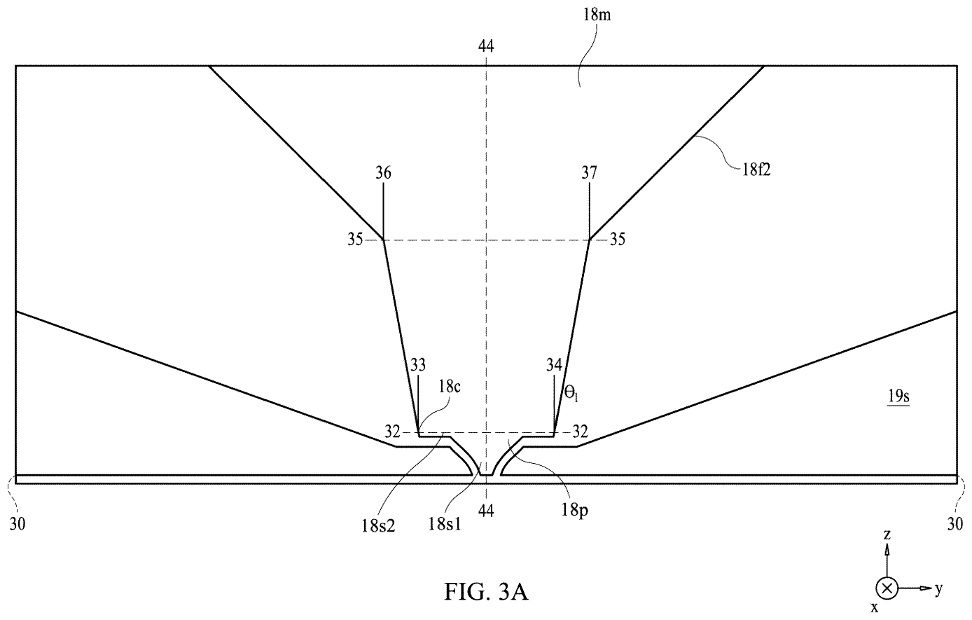

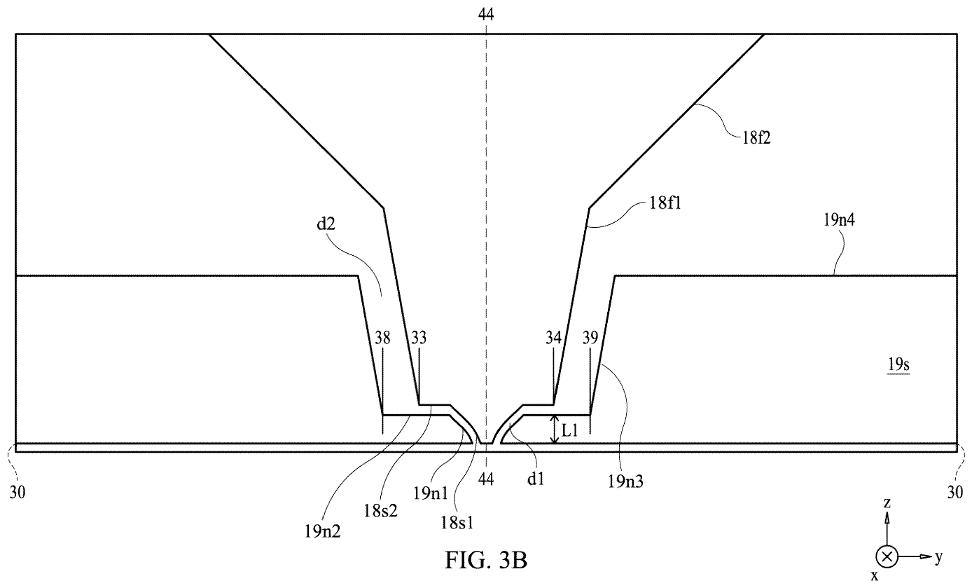

FIG. 3A shows a top-down view of the side shield and main pole structure of another writer with the trailing shield and write gap removed. FIG. 3B shows a top-down view of the side shield and main pole structure of a writer according to some embodiments of the present disclosure with the trailing shield and write gap removed. The features of the main pole are shared by both writer designs shown in FIGS. 3A and 3B. FIG. 3A shows a writer having a conventional side shield. FIG. 3B shows a writer having the improve side shield according to some embodiments of the present disclosure.

The main pole includes a back portion 18m and a front portion of the main pole also known as the write pole 18p has a trailing edge 14t at the ABS, and has a curved sidewall on each side of the center plane 44-44 wherein a first portion 18s1 of curved sidewall is proximate to the ABS, and a second portion 18s2 is proximate to corner 18c where the curved sidewall connects with first flared side 18f1 of the main pole back portion.

In some embodiments, first flared side 18f1 of the main pole back portion flare outward from dashed lines 33, 34, which are perpendicular to the ABS 30-30 and parallel to the center plane 44-44, at an angle θ₁ from the plane 32-32. The angle θ₁ is preferably between 0 degrees and 25 degrees. In some embodiments, first flared side 18f1 can maintain the angle θ₁ through the back portion 18m. In some embodiments, first flared side 18f1 connects with second flared side 18f2 at about 0.3 μm to 1.0 μm from the ABS at plane 35-35. In some embodiments, second flared side 18f2 flare outward from dashed lines 36, 37, which are perpendicular to the ABS 30-30 and parallel to the center plane 44-44, at an angle θ₂ from the plane 35-35. In some embodiments, angle θ₂ is more than angle θ₁. In some embodiments, angle θ₂ is between 30 degrees and 60 degrees. Without being bound to any particular theory, the main pole will exert less field onto the side shield as the angle θ₁ decreases. Thus, the side shield stray field can be reduced and ATI and TPI can improve accordingly.

In some embodiments, first portion 18s1 forms an angle from 0 to 40 degrees, and preferably 18-20 degrees, with respect to center plane 44-44. In general, as the angle increases, the cross-track magnetic field gradient degrades. However, as the angle approaches 0 degrees, the magnetic field from the main pole decreases dramatically. Therefore, an angle of 18 to 20 degrees is a preferable range to maintain an acceptable cross-track field gradient and magnetic field from the main pole.

As shown in FIG. 3B, in some embodiments, the side shields 19s each have a first sidewall section 19n1 proximate to the ABS 30-30 and substantially conforming to the shape of the first curved sidewall portion 18s1 of the main pole. In some embodiments, the first sidewall section 19n1 has a front end at the ABS and is separated from the first curved sidewall portion 18s1 of the main pole by a first side gap distance d1 as a first step of the side shields 19s. In some embodiments, the side shields 19s includes a second sidewall section 19n2 that is proximate to the corner 18c where the curved sidewall connects with flared side 18f of the main pole back portion. In some embodiments, the second sidewall section 19n2 is formed substantially conformal to curved sidewall portion 18s2 up to a height h1 of 10 to 200 nm at the first side gap distance d1 from the first portion 18s1. In some embodiments, the second sidewall section 19n2 is formed substantially conformal to curved sidewall portion 18s2 up to a height h1 of 10 to 200 nm at the first side gap distance d1 from the first portion 18s1 and up to dashed lines 33, 34. In some embodiments, the height h1 is 20 to 180 nm, 20 to 160 nm, 20 to 140 nm, 20 to 120 nm, 20 to 100 nm, 20 to 80 nm, 40 to 180 nm, 40 to 160 nm, 40 to 140 nm, 40 to 120 nm, 40 to 100 nm, 40 to 80 nm, 50 to 180 nm, 50 to 160 nm, 50 to 140 nm 50 to 150 nm, 50 to 140 nm, 50 to 130 nm, 50 to 120 nm, 50 to 110 nm, or 50 to 100 nm.

In some embodiments, the first side gap distance d1 is about 5 nm to 100 nm up to the height h1. In some embodiments, the first side gap distance d1 is about 20 nm to 60 nm up to the height h1. In some embodiments, the first side gap distance d1 is about 10 nm to 90 nm, 20 to 80 nm, 30 to 70 nm, 40 to 60 nm or 25 to 75 nm.

In some embodiments, the first side gap distance d1 is substantially uniform up to dashed lines 33, 34 which are perpendicular to the ABS 30-30 and parallel to the center plane 44-44. In some embodiments, the first side gap distance d1 is substantially uniform up to the corner 18c where the curved sidewall connects with flared side 18f of the main pole back portion.

In some embodiments, the portion of the second sidewall section 19n2 between dashed lines 33, 34 and dashed lines 38,39 remains substantially conformal to curved sidewall portion 18s2. In some embodiments, the portion of the second sidewall section 19n2 between dashed lines 33, 34 and dashed lines 38,39 is formed essentially parallel to the ABS 30-30 at a step height h1.

In some embodiments, as a second step of the side shields 19s, a back end of the second sidewall section 19n2 is connected to a front end of a third sidewall section 19n3 of the side shield 19s. In some embodiments, the third sidewall section 19n3 is substantially conformal to the first flared side 18f1 of the main pole back portion at a second side gap distance d2 from the first flared side 18f1 of the main pole. In other words, the taper angle of the first flared portion 18f1 relative to dashed lines 33, 34 is substantially the same as the taper angle of the third side wall section 19n3 relative to dashed lines 38, 39. In some embodiments, the taper angle θ₁ of the first flared portion 18f1 relative to dashed lines 33, 34 and the taper angle of the third side wall section 19n3 relative to dashed lines 38, 39 is about 0 to 25 degrees.

In some embodiments, the width of the second side gap distance d2 is larger than the first side gap distance d1 by about 5 to 200 nm. In some embodiments, the second side gap distance d2 is larger than the first side gap distance d1 by about 10 to 180 nm, 20 to 170 nm, 30 to 160 nm, 40 to 150 nm, 50 to 140 nm, 60 to 130 nm, 70 to 120 nm, 20 to 180 nm, 20 to 160 nm, 20 to 140 nm, 20 to 120 nm, 20 to 100 nm, 20 to 80 nm, 40 to 180 nm, 40 to 160 nm, 40 to 140 nm, 40 to 120 nm, 40 to 100 nm, 40 to 80 nm, 50 to 180 nm, 50 to 160 nm, 50 to 140 nm 50 to 150 nm, 50 to 140 nm, 50 to 130 nm, 50 to 120 nm, 50 to 110 nm, or 50 to 100 nm.

In some embodiments, the second side gap distance d2 is about 10 to about 300 nm. In some embodiments, the second side gap distance d2 is about 20 to 280 nm, 30 to 270 nm, 40 to 260 nm, 50 to 250 nm, 60 to 240 nm, 70 to 230 nm, 80 to 220 nm, 90 to 210 nm, 100 to 200 nm, 100 to 190 nm, 100 to 180 nm, 100 to 170 nm, 100 to 160 nm, or 100 to 150 nm.

In some embodiments, the side shields 19s further include a fourth sidewall section 19n4 connected to a back end of the third sidewall section 19n3. In some embodiments, the fourth sidewall section 19n4 no longer follows the shape of the write pole and continues to an end 19e at sides 60 (or 61) of the side shield. In some embodiments, the fourth sidewall section 19n4 is essentially parallel to the ABS 30-30. In some embodiments, the fourth sidewall section 19n4 is about 0.3 μm to 1.0 μm from the ABS, but at a height less than the plane 35-35 where the first flared side 18f1 connects with second flared side 18f2.

Without being bound to any particular theory, it is believed that the second step of the side shields enhances the shielding effect and reduces the side shield stray field. The width of the larger second side gap distance d2 can still allow for the release of MP flux to maintain the write field in the track center.

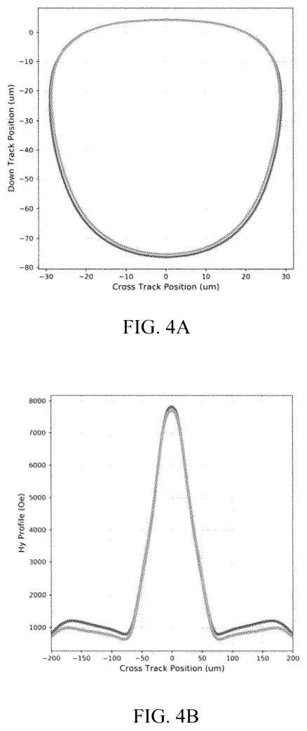

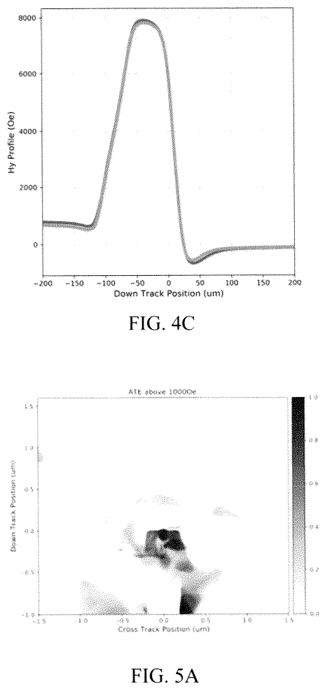

FIGS. 4A-C is a comparison of the static modeling result of the write field profile 15 nm below ABS for the writers of FIGS. 3A and 3B, in which static modeling is based on Maxwell equations. For exemplary purposes, the writer of FIG. 3B includes a first side gap distance d1 of 50 nm, a second side gap distance d2 of 130 nm and a height h1 of 80 nm above ABS level. FIG. 4A is a comparison of the 5 kOe contour plot for the writers. FIG. 4B shows the write field (Hy) profile along the cross-track direction for the conventional writer and the writer according to some embodiments of the present disclosure. FIG. 4C shows the write field (Hy) profile along the down-track direction for the conventional writer and the writer according to some embodiments of the present disclosure. As shown in FIG. 4A, the new side shield as shown in FIG. 3b can narrow help narrow the erase width during AC mode (EWAC) while maintain the trailing side write bubble curvature. In FIG. 4B, it is demonstrated that the new side shield as shown in FIG. 3B can help lower the side shield related stray field (causing adjacent track interference) due to more shielding effect in the side gap. In FIG. 4C, it is demonstrated that the new side shield as shown in FIG. 3B has little to no influence on the track center maximum write field (Hy) along the down-track direction and the trailing side response as the larger still can secure the outlet of MP field to media level. Therefore, the writer according to some embodiments of the present disclosure have more optimal MP field release and effective shielding in the cross track direction than the writer in FIG. 3a without the improved side shield and, as a result, the new writer can effectively increase TPI capability with little BPI tradeoff.

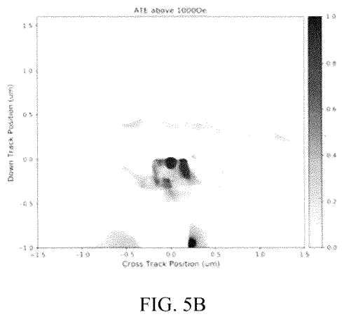

FIGS. 5A-B show a stray field plot at media level (15 nm below ABS) through dynamic modeling of the stray field in (a) writer with a conventional side shield and (b) writer with the improved side shield. FIG. 5A-B only show the stray field above 1000 Oe and show the improvement in stray field under dynamic write current switching. FIG. 5B showing the stray field plot for the writer having the improved side shield clearly demonstrates cleaner side shield related stray field than the writer having the conventional side shield, indicating less adjacent track interference (ATI) and therefore better TPI potential.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A magnetic recording writer, comprising:
a main pole having a front portion and a back portion, the front portion includes a pole tip at an air bearing surface (ABS) plane, a pole tip thickness in a down-track direction, and curved sidewalls on each side of a center plane that is orthogonal to the ABS and bisects the main pole, the back portion includes first flared sidewalls connecting to the curved sidewalls at corners and extending from the curved sidewalls at an angle between 0 and 45 degrees relative to planes parallel to the center plane;
a shield structure including a side shield on each side of the center plane, a leading shield, and a trailing shield forming an all wrap around (AWA) shield structure, the side shields each comprise a first sidewall portion proximate to the ABS facing the curved sidewalls of the main pole and formed substantially conformal to the curved sidewalls up to a height of about 10 to 200 nm above the ABS, a second sidewall portion proximate to the corner connecting the first flared sidewalls and the curved sidewalls and formed substantially conformal to the curved sidewalls up to the height of about 10 to 200 nm above the ABS, a third sidewall portion connected to the second sidewall portion and formed substantially conformal to the first flared sidewall, and a fourth sidewall portion connected to the third sidewall portion and formed substantially parallel to the ABS; and
a side gap separating the main pole from each side shield.

2. The writer of claim 1, wherein the side gap includes a first side gap distance having a width of about 5 nm to 100 nm up to the height of about 10 to 200 nm above the ABS.

3. The writer of claim 2, wherein the side gap further includes a second side gap distance above the height of about 10 to 200 nm above the ABS and having a width of about 5 nm to about 200 nm more than the width of the first side gap distance.

4. The writer of claim 2, wherein the second side gap distance is about 10 to about 300 nm.

5. The writer of claim 2, wherein the first side gap distance is substantially uniform from the ABS up to the height of about 10 to 200 nm.

6. The writer of claim 3, wherein the second side gap distance is substantially uniform from the height of about 10 to 200 nm up to the fourth sidewall portion formed substantially parallel to the ABS.

7. The writer of claim 1, wherein the fourth sidewall portion is formed at a height of about 0.3 μm to 1.0 μm from the ABS.

8. The writer of claim 1, wherein the third sidewall portion of each side shield is formed substantially at the same angle as the first flared sidewalls relative to planes parallel to the center plane.

9. The writer of claim 1, wherein the first flared sidewalls are formed at an angle between 0 and 25 degrees relative to planes parallel to the center plane.

10. The writer of claim 1, wherein the first flared sidewalls are formed at an angle between 30 and 45 degrees relative to planes parallel to the center plane.

11. The writer of claim 9, wherein the third sidewall portion of each side shield is formed at an angle between 0 and 25 degrees relative to planes parallel to the center plane.

12. The writer of claim 10, wherein the third sidewall portion of each side shield is formed at an angle between 30 and 45 degrees relative to planes parallel to the center plane.

13. The writer of claim 11, wherein the third sidewall portion of each side shield is formed substantially at the same angle as the first flared sidewalls relative to planes parallel to the center plane.

14. The writer of claim 12, wherein the third sidewall portion of each side shield is formed substantially at the same angle as the first flared sidewalls relative to planes parallel to the center plane.

15. The writer of claim 1, wherein the first flared sidewalls are formed at an angle between 0 and 25 degrees relative to planes parallel to the center plane, and the back portion further includes second flared sidewalls extending from the first flared sidewalls at an angle between 30 and 60 degrees relative to planes parallel to the center plane.

16. The writer of claim 15, wherein the second flared sidewalls extend from the first flared sidewalls starting at about 0.3 μm to 1.0 μm from the ABS.

17. The writer of claim 15, wherein the fourth sidewall portion is closer to the ABS than the second flared sidewalls.
